(19) United States
(12) Patent Application Publication
(10) Pub. No.: US 2012/0203277 A1
(43) Pub. Date: Aug. 9, 2012

(54) Photograph Teething Device and Methods Thereof

(76) Inventor: Amy R. Forestieri, Bennett, CO (US)

(21) Appl. No.: 13/022,362

(22) Filed: Feb. 7, 2011

(51) Int. Cl. A61J 17/00

(52) U.S. Cl. 606/235

(57) ABSTRACT

Photograph teething devices and various methods thereof are disclosed herein. A photograph teething device includes a body section and an attachment section. The body section typically has a first side surface, a second side surface, an interior portion, and an external portion. The interior portion includes a photographic image and may also include text. The external portion of the body section is substantially transparent, yet may include a color or hue in the external portion. Moreover, the external portion is comprised of a babyproof material and typically encapsulates the interior portion.

Methods of making the photograph teething device include selecting characteristics of the photograph teething device, uploading a photograph, and entering text. Methods of using the photograph teething device include using them as at least one security check for persons authorized to pick up a child in a facility, such as a day-care facility or preschool.

### FIELD OF THE INVENTION

The present invention relates generally to teething devices for infants and toddlers. More particularly, the present invention relates to teething devices having photographs therein and methods of using and making the same.

### BACKGROUND

Many infants and toddlers spend a significant time away from their parents at a day-care or preschool setting, which can be somewhat of an emotional challenge for the child. Additionally, one of the child's parents may frequently travel for work or be deployed oversees on a military assignment. Moreover, many friends and relatives of the child and child's parents live in distant cities. Thus, an infant or toddler's limited exposure to a parent, relative, or family friend may inhibit the child's ability to develop a familiarity or recognition of that person on a cognitive level.

It is often said that young children learn through their senses, particularly through their mouths as infants during the early stages of their lives while frequently nursing and feeding. As young children grow, they continue to learn through touching, watching, and listening. Hence, many concerned and loving parents, relatives, and family friends seek a way to utilize a young child's learning methods in order to both comfort a young child and aid in the development of the young child's cognitive recognition of the parent, relative, and family friend.

Heretofore, devices and method of using and making the same to provide comfort for a young child in a day-care or preschool setting and to aid in developing the young child's cognitive recognition of a family member or friend remains a long felt need.

### BRIEF DESCRIPTION OF THE FIGURES

FIG. 1A is a front perspective view of a photograph teething device according to a first embodiment.

FIG. 1B is a bottom view of a photograph teething device according to a first embodiment.

FIG. 2A is a front perspective view of a photograph teething device according to a second embodiment.

FIG. 2B is a bottom view of a photograph teething device according to a second embodiment.

FIG. 3A is a front perspective view of a photograph teething device according to a third embodiment.

FIG. 3B is a bottom view of a photograph teething device according to a third embodiment.

FIG. 4A is a front perspective view of a photograph teething device according to a fourth embodiment.

FIG. 4B is a bottom view of a photograph teething device according to a fourth embodiment.

FIG. 5A is a front perspective view of a photograph teething device according to a fifth embodiment.

FIG. 5B is a back perspective view of a photograph teething device according to a fifth embodiment.

FIG. 6 is a flow chart of an exemplary method of making a photograph teething device according to an embodiment.

FIG. 7 is a flow chart of an exemplary method of using one or more photograph teething device according to an embodiment.

### DETAILED DESCRIPTION

Embodiments of the present invention include photograph teething device and method of making and using the same. Each exemplary photograph teething device generally comprises a body section and an attachment section. The body section includes a photographic image. The photographic image is typically a rendition of a person such as a relative or family friend of a child (typically an infant or toddler). The photographic image is typically contained on or within an interior portion of the body section. Additionally, the interior portion is encapsulated by a substantially transparent exterior portion of the body section comprised of a babyproof material. Moreover, the exterior portion includes characteristics to encourage the child to bite on the device. Thus, embodiments of the photograph teething device allow and encourage the child to chew on and touch the device thereby increasing his or her engagement with the photographic image therein.

Embodiments of the photograph teething device typically include text. The text can identify the name of the person represented in the photographic image or provide information regarding the photographic image. Some embodiments of the photograph teething device include one or more attraction implements adapted to draw the child's attention to the device, such as lights or the sound of a recorded voice of the person depicted in the photographic image. In yet other embodiments, the other implements such as, but not limited to, an RFID tag or chip, or transmitter, may be included in the photograph teething device. The attachment section of the photograph teething device is adapted to be removably coupled to an object. In use, the photograph teething device can easily be attached to various items such as, but not limited to, a car seat, stroller, toy bar, play pen, and crib. Moreover, a person can wear the photograph teething device around his or her neck on a lanyard thereby allowing an infant to gum, chew, touch, and/or observe the photograph teething device while the person carries the infant, for example.

Thus, when a child is at a facility, such as a day-care facility or a preschool, the child can have an omnipresent picture of a loved one, as well as a loved one's voice in some embodiments. Infants are able to distinguish voices and can be soothed by hearing his or her mother's voice, for example. Additionally, when the child is at home or otherwise he or she will have the omnipresent picture of loved ones such as a grandparent, aunt, uncle, cousin, etc. living in distant cities. The photograph teething device enables the child to learn through his or her senses and develop a cognitive recognition of his or her family members at an early age. Hence, the child is less likely to react as if the family members are strangers when they visit. Moreover, the photograph teething device can be instrumental to a child's cognitive recognition and emotional development when one of the child's parents is deployed in the military, works evening/night shifts, or travels frequently.

An exemplary method of making the photograph teething devices includes using an on-line system or in-store kiosk to enable customization of the devices and allow relatives and friends living in distant cities to create a customized photograph teething device. Additional methods of using the photograph teething devices include using one or more photograph teething device as a method to identify authorized persons to pick-up a child in a facility such as a day-care facility or preschool. Similarly, the photograph teething device can be used to calm and comfort children staying in a hospital or during an extended absence from their parents or relatives.

### Terminology

The terms and phrases as indicated in quotes (“ ”) in this section are intended to have the meaning ascribed to them in this Terminology section applied to them throughout this document including the claims unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive rather the term is inclusive meaning: either or both.

References in the specification to “one embodiment”, “an embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

The term “removable,” “removably coupled,” “readily removable,” “threadably coupled,” and similar terms, as used in this specification and appended claims, refer to structures that can be uncoupled from an adjoining structure with relative ease (i.e., non-destructively and without complicated or time consuming process), and can also be readily reattached or coupled to the previously adjoining structure.

Directional and/or relationary terms such as, but not limited to, left, right, top, bottom, vertical, horizontal, back, front and lateral are relative to each other and are dependent on the specific orientation of an applicable element or article, and are used accordingly to aid in the description of the various embodiments and are not necessarily intended to be construed as limiting.

As applicable, the terms “about” and “generally” as used herein unless otherwise indicated mean a margin of +−20%. Also, as applicable, the term “substantially” as used herein unless otherwise indicated means a margin of +−10%. Concerning angular measurements, “about” or “generally” refer to +−10 degrees and “substantially” refers to +−5.0 degrees unless otherwise indicated. It is to be appreciated that not all uses of the above terms are quantifiable such that the referenced ranges can be applied.

The term “babyproof material” as used in this specification and appended claims refers to any non-toxic substance suitable for use by children. Suitable substances include, but are not limited to, silicone, natural rubber, or like substances that are lead-free, phthalate-free, bisphenol A (BPA)-free, latex free, and polyvinyl chloride free.

### Exemplary Embodiments of a Photograph Teething Device

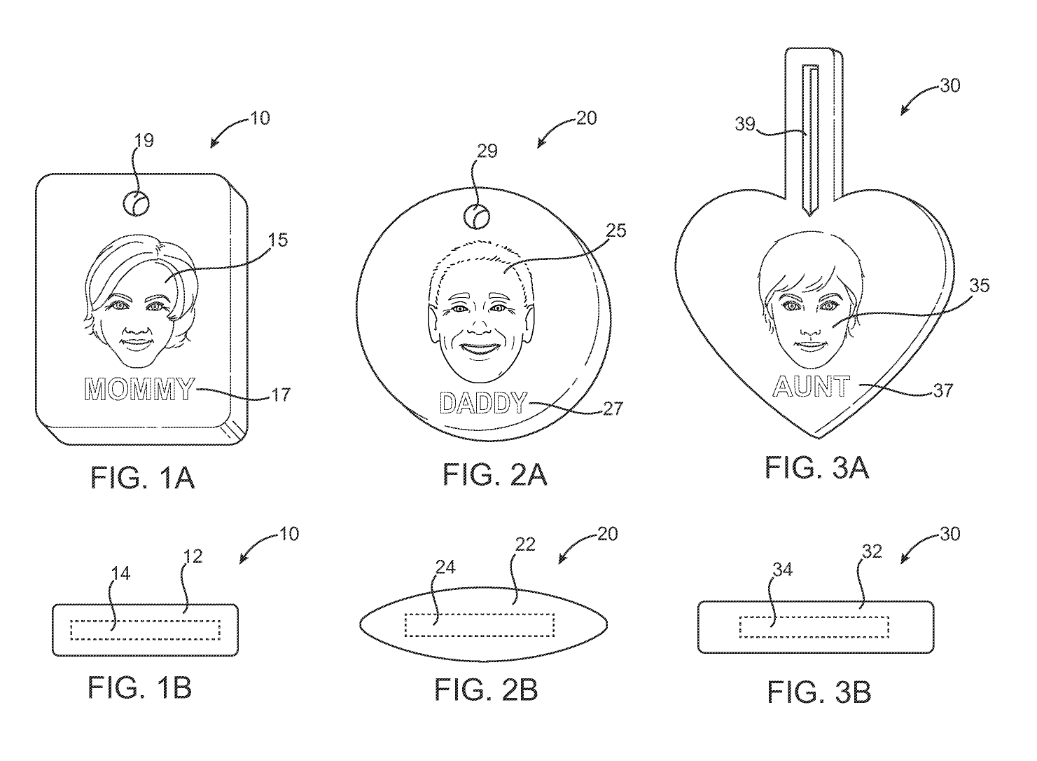

Exemplary embodiments of a photograph teething device are illustrated in FIGS. 1 through 5. Each exemplary photograph teething device generally comprises a body section and an attachment section. The body section comprises a first side surface, a second side surface, an interior portion comprising a photographic image, and an external portion. The interior portion can be comprised of a hardened clear plastic material thereby completely encapsulating the photographic image therein. The photographic image is typically a rendition of a person that is created using standard techniques known in the art such as using a camera and photographic film or an electronic imager/digital camera and printer. However, any rendition like a cartoon version or sketch may be used as the photographic image depicting a person in some embodiments. Additionally, the photographic image does not necessarily have to be generated on film or paper as the ink or color may be applied directly to the material of the interior portion of the body section.

The external portion encapsulates the interior portion and is typically substantially transparent. Importantly, the external portion is comprised of a babyproof material. Moreover, the babyproof material is typically semi-rigid including some pliable or rubbery characteristics to encourage a child (typically an infant or toddler) to bite on the device. For example, in some embodiments the exterior portion can have a Durometer or Shore A hardness value between approximately 30 and 60. Other embodiments may include exterior portions having a Durometer or Shore A hardness value below approximately 30. However, other embodiments are contemplated where the external portion is extremely hard and rigid.

Embodiments of the photograph teething device typically include text. The text can identify the name of the person represented in the photographic image or provide information regarding the photographic image. However, in some embodiments the text fields can be used for other purposes. Additionally, some text can be visible from a first side surface, such as the front side of the photograph teething device, and other text can be visible from a second side surface, such as the back side of the photograph teething device. In some embodiments, the various images (photograph, text and/or both) can be seen through the surfaces of the first side and second side. Importantly, the photographic image and any text are substantially sealed by the exterior portion to prevent the child from ingesting the ink or other chemicals and to prevent the photographic image and text from rubbing-off.

Additionally, some embodiments of the photograph teething device include one or more attraction implements adapted to draw the child's attention to the device. In yet other embodiments, the other implements such as, but not limited to, an RFID tag or chip, transmitter, may be included in the photograph teething device.

The overall size of the photograph teething device is dependent on the specific embodiment, but is typically approximately 2 inches to 6 inches in circumference, length or width and approximately ⅛ inch to 2 inches in thickness. While extremely small sizes are generally not contemplated given the potential as choking hazards, much larger size are contemplated in some embodiments. It is also pertinent to note that shape of the photograph teething devices is not limited to generally square, rectangular, or circular shapes, but may encompass various polygon and irregular shapes in some embodiments.

Various types of attachment sections are contemplated. Several exemplary attachment sections are illustrated in FIGS. 1 through 5, but embodiments of the photograph teething device can comprise any type of attachment section adapted to removable couple the photograph teething device to an object. In use, the photograph teething device can easily be attached to various items such as, but not limited to, a car seat, stroller, toy bar, play pen, crib, and directly to a person via a lanyard.

Referring to FIGS. 1A & 1B, a first embodiment photograph teething device 10 is illustrated. A body section of the first embodiment photograph teething device 10 is generally rectangular. The body section of the first embodiment photograph teething device 10 has a generally rectangular first side surface and a generally rectangular second side surface. Either the first side can be designated a front side of the first embodiment photograph teething device 10 and the second side surface designated a back side surface; or the second side surface can be designated the front side surface and the first side surface be designated the back side surface. Both the first and second side surfaces of the first embodiment photograph teething device 10 are substantially planar as best illustrated in FIG. 1B. One or more edges or edge surfaces are defined around the general outer circumference defined by the first and second side surfaces. The one or more edges defining the corners of the first embodiment photograph teething device 10 are typically rounded to eliminate any sharp edges as the child play's with and chews on the device.

Additionally, the body section includes an interior portion 14 and an exterior portion 12. As can be seen from the cross-sectional view of FIG. 1B, the interior portion 14 is disposed in the general center of the first embodiment photograph teething device 10 and encapsulated by the exterior portion 12. However, in some implementations, the interior and exterior portions can be basically a single unitary piece without any clear definitions between the portions.

A photographic image 15 is enclosed or encapsulated within the interior portion 14. As illustrated in FIG. 1A, the photographic image 15 can be a rendition of a child's mother. Given, the overall size of the photograph teething device, the photographic image 15 is typically a head shot or similar close-up picture. Additionally, text 17 identifying the photographic image 15 is typically included within the interior portion 14. As illustrated, the text 17 can be “Mommy” indentifying the person rendered in the photographic image 15.

The first embodiment photograph teething device 10 also comprises an attachment section 19. The attachment section 19 can be an aperture that extends through the first side surface and the second side surface. Therefore, the first embodiment photograph teething device 10 can be easily attached to a variety of objects.

Referring now to FIGS. 2A & 2B, a second embodiment photograph teething device 20 is illustrated. A body section of the second embodiment photograph teething device 20 is generally circular and shaped similar to a double convex lens. The body section of the second embodiment photograph teething device 20 has a generally circular and substantially convex first side surface and a generally circular and substantially convex second side surface. Either the first side can be designated a front side of the second embodiment photograph teething device 20 and the second side surface designated a back side surface; or the second side surface can be designated the front side surface and the first side surface be designated the back side surface. Both the first and second side surfaces of the second embodiment photograph teething device 20 are substantially convex as best illustrated in FIG. 2B. An edge or edge surface is defined around the general outer circumference defined by the first and second side surfaces. However, variation of the second embodiment photograph teething device 20 can have a plurality of edges or edge surfaces where it is a generally circular polygon (e.g., a heptagon or a dodecagon).

Additionally, the body section includes an interior portion 24 and an exterior portion 22. As can be seen from the cross-sectional view of FIG. 2B, the interior portion 24 is disposed in the general center of the second embodiment photograph teething device 20 and encapsulated by the exterior portion 22. However, in some implementations, the interior and exterior portions can be basically a single unitary piece without any clear definitions between the portions.

A photographic image 25 is enclosed or encapsulated within the interior portion 24. As illustrated in FIG. 2A, the photographic image 25 can be a rendition of a child's father. Given, the overall size of the photograph teething device, the photographic image 25 is typically a head shot or similar close-up picture. Additionally, text 27 identifying the photographic image 25 is typically included within the interior portion 24. As illustrated, the text 27 can be “Daddy” indentifying the person rendered in the photographic image 25.

Still referring to FIG. 2A, the second embodiment photograph teething device 20 also comprises an attachment section 29. The attachment section 29 can be an aperture that extends through the first side surface and the second side surface. Therefore, like the first embodiment, the second embodiment photograph teething device 20 can be easily attached to a variety of objects.

FIGS. 3A & 3B illustrate a third embodiment photograph teething device 30. A body section of the third embodiment photograph teething device 30 is generally heart shaped. The body section of the third embodiment photograph teething device 30 has a generally heart shaped first side surface and a generally heart shaped second side surface. Either the first side can be designated a front side of the third embodiment photograph teething device 30 and the second side surface designated a back side surface; or the second side surface can be designated the front side surface and the first side surface be designated the back side surface. Both the first and second side surfaces of the third embodiment photograph teething device 30 are substantially planar as best illustrated in FIG. 3B. However, variations of the third embodiment photograph teething device 30 can include a first and second side surface that is substantially convex like the second embodiment photograph teething device 20 (FIG. 2B). One or more edges or edge surfaces are defined around the general outer circumference defined by the first and second side surfaces. The one or more edges defining the corners of the third embodiment photograph teething device 30 are typically rounded to eliminate any sharp edges as the child play's with and chews on the device.

Additionally, the body section includes an interior portion 34 and an exterior portion 32. As can be seen from the cross-sectional view of FIG. 3B, the interior portion 34 is disposed in the general center of the third embodiment photograph teething device 30 and encapsulated by the exterior portion 32. However, in some implementations, the interior and exterior portions can be basically a single unitary piece without any clear definitions between the portions.

In some implementations, the interior portion and/or the exterior portion can include a color dye. The color dye is typically infused in the exterior portion 32 so as to not interfere with or adversely affect the photographic image 35 during construction of the device. However, the color dye can be added to all or a portion of the interior portion 34 in some implementations and may be dispersed such that it does not obstruct the view of the photographic image 35. The amount of color dye can be adjusted so that the exterior portion 32 retains its generally transparent properties. Of course, the color dye should be nontoxic and have similar general babyproof properties as the external portion 32. For example, the third embodiment photograph teething device 30 can include a light red dye to resemble a heart. Moreover, patterns (either using a color dye or otherwise) can be added to the interior portion and/or the exterior portion for extra attraction effect.

A photographic image 35 is enclosed or encapsulated within the interior portion 34. As illustrated in FIG. 3A, the photographic image 35 can be a rendition of a child's aunt. Given, the overall size of the photograph teething device, the photographic image 35 is typically a head shot or similar close-up picture. Additionally, text 37 identifying the photographic image 35 is typically included within the interior portion 34. As illustrated, the text 37 can be “Aunt” indentifying the person rendered in the photographic image 35.

Still referring to FIG. 3A, the third embodiment photograph teething device 30 also comprises an attachment section 39. The attachment section 39 can comprise an elongated segment of the substantially transparent external portion. The elongated segment can also have an elongated aperture. The attachment section 39 is adapted to attach to an object by wrapping a portion of the elongated segment around the object (usually a bar, tube or similarly elongated member) and the passing the body section passed through the elongated aperture. However, in some variations, the attachment section can be a single elongated segment (rectangular, circular, or the like) that can be tied in a knot to attach the photograph teething device to an object. Hence, the third embodiment photograph teething device 30 can be easily attached to a variety of objects, particularly those having bars or shafts (e.g., a crib or bassinet).

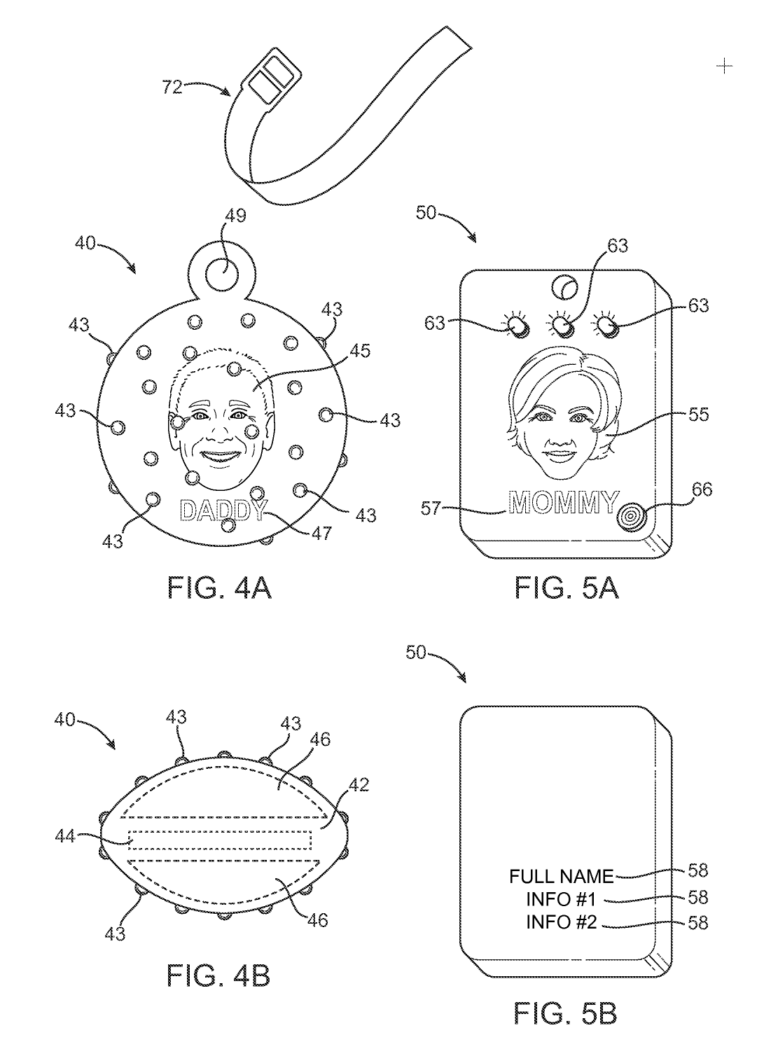

Referring now to FIGS. 4A & 4B, a fourth embodiment photograph teething device 40 is illustrated. A body section of the fourth embodiment photograph teething device 40 is generally circular and shaped similar to a very thick double convex lens. The body section of the fourth embodiment photograph teething device 40 has a generally circular and substantially convex first side surface and a generally circular and substantially convex second side surface. Either the first side can be designated a front side of the fourth embodiment photograph teething device 40 and the second side surface designated a back side surface; or the second side surface can be designated the front side surface and the first side surface be designated the back side surface.

Both the first and second side surfaces of the fourth embodiment photograph teething device 40 are substantially convex as best illustrated in FIG. 4B. Additionally, the first side surface and the second side surface of the fourth embodiment photograph teething device 40 can be substantially textured with a plurality of protrusions 43. However, the texturing of the surfaces can be in various forms. By way of example, but not limitation, the texturing can be ribbed, ridged, or roughed to entice a baby to bite on the photograph teething device. An edge or edge surface is defined around the general outer circumference defined by the first and second side surfaces; however, variation of the fourth embodiment photograph teething device 40 can have a plurality of edges or edge surfaces. Moreover, the protrusion 43 can extend from the edge as well as the first and second surfaces.

Additionally, the body section includes an interior portion 44 and an exterior portion 42. As can be seen from the cross-sectional view of FIG. 4B, the interior portion 44 is disposed in the general center of the fourth embodiment photograph teething device 40 and encapsulated by the exterior portion 42. Additionally as illustrated in the cross-sectional view of FIG. 4B, the fourth embodiment photograph teething device 40 can include one or more fluid cavities 46. Typically, water or a non-toxic freezable gel is disposed within the one or more fluid cavities 46. Thus, the fourth embodiment photograph teething device 40 can be cooled or frozen prior to use to provide additional comfort to a teething infant. However, other fluids can be included in the one or more fluid cavities 46 such as but not limited to air (to make the device more pliable).

A photographic image 45 is enclosed or encapsulated within the interior portion 44. As illustrated in FIG. 4A, the photographic image 45 can be a rendition of a child's father. Given, the overall size of the photograph teething device, the photographic image 45 is typically a head shot or similar close-up picture. Additionally, text 47 identifying the photographic image 45 is typically included within the interior portion 44. As illustrated, the text 47 can be “Daddy” indentifying the person rendered in the photographic image 45.

Still referring to FIG. 4A, the fourth embodiment photograph teething device 40 also comprises an attachment section 29. The attachment section 29 can be a ring portion having an aperture. Therefore, like other embodiment, the fourth embodiment photograph teething device 40 can be easily attached to a variety of objects. For example, a baby-safe strap 72 can be used to removably couple the device to an object.

A final exemplary embodiment is illustrated in FIGS. 5A & 5B. A fifth embodiment photograph teething device 50 includes a body section that is generally rectangular. The body section of the fifth embodiment photograph teething device 50 has a generally rectangular first side surface and a generally rectangular second side surface. Either the first side can be designated a front side of the fifth embodiment photograph teething device 50 and the second side surface designated a back side surface; or the second side surface can be designated the front side surface and the first side surface be designated the back side surface. Both the first and second side surfaces of the fifth embodiment photograph teething device 50 are substantially planar. The fifth embodiment photograph teething device 50 may be slightly thicker than similar embodiments (e.g., the first embodiment photograph teething device 10) in order to incorporate the additional elements therein. One or more edges or edge surfaces are defined around the general outer circumference defined by the first and second side surfaces. The one or more edges defining the corners of the fifth embodiment photograph teething device 50 are typically rounded to eliminate any sharp edges as the child play's with and chews on the device.

Additionally, the body section includes an interior portion and an exterior portion. Similar to other embodiments, the interior portion is disposed in the general center of the fifth embodiment photograph teething device 50 and encapsulated by the exterior portion. However, in some implementations, the interior and exterior portions can be basically a single unitary piece without any clear definitions between the portions.

A photographic image 55 is enclosed or encapsulated within the interior portion. As illustrated in FIG. 5A, the photographic image 55 can be a rendition of a child's mother. Given, the overall size of the photograph teething device, the photographic image 55 is typically a head shot or similar close-up picture. Additionally, text 57 identifying the photographic image 55 is typically included within the interior portion. As illustrated, the text 57 can be “Mommy” indentifying the person rendered in the photographic image 55.

Referring now to FIG. 5B, informational text 58 can be included on the either the first of second side surface. The informational text 58 typically comprises information regarding the photographic image 55. Non-limiting examples informational text 58 include the full name of the person rendered in photographic image 55, the person contact information (e.g., home phone, mobile phone, work phone, home email address, and work email address). When the fifth embodiment photograph teething device 50 is also used as a security check or method for authorizing persons to pick-up the child in a facility, the informational text 58 can additionally include, for example, contact information such as email addresses and phone numbers. Additionally, in some variations the informational text can include a full name, height and weight of the person in the photographic image as well as an answer to a security question or other ways to identify the person attempting to remove the child from the facility.

The fifth embodiment photograph teething device 50 comprises one or more attraction implements. The one or more attraction implements are adapted to draw the child's attention to the fifth embodiment photograph teething device 50 and are completely encapsulated by the external portion of the body section. Typically, but not necessarily, the one or more attraction implements are encompassed within the interior portion as well. The one or more attraction implements can be a light system adapted to emit light. For example, the light system can include one or more LEDs 63 adapted to flash either randomly or by motion or pressure activation. The one or more attraction implements can also include an audio system adapted to store an audio file and emit sound for a small internal speaker 66. Standard miniaturized electronics and batteries as know in the art are typically used to create and power the one or more attraction implements. In some variations, the device can include a RFID tag or chip or the like such that a facility can detect when the child arrives or leaves the facility. The RFID tag or chip may be passive thereby requiring no power or may be include integrated circuits thereby requiring power. Standard miniaturized electronics and batteries as know in the art are typically used to create and power the one or more attraction implements or an RFID tag or chip or the like.

The fifth embodiment photograph teething device 50 also comprises an attachment section 59. The attachment section 59 can be an aperture that extends through the first side surface and the second side surface. Therefore, like other embodiments the fifth embodiment photograph teething device 50 can be easily attached to a variety of objects.

Further variations and alternative embodiments of the photograph teething device are contemplated as would be apparent to one of skill in the art having the benefit of this disclosure. It is to be appreciated that any feature, element, implementation, or variation discussed with respect to any of the embodiments illustrated in FIGS. 1 through 5 can be applied to the other embodiments referenced and/or contemplated in this disclosure.

### An Exemplary Method of Making Photograph Teething Devices

An exemplary method of making embodiments of a photograph teething device is additionally disclosed herein. It is to be understood that the first, second, third, fourth, and fifth embodiment photograph teething devices 10, 20, 30, 40, and 50, as well as other embodiments and variations can be made with this exemplary method of making photograph teething devices.

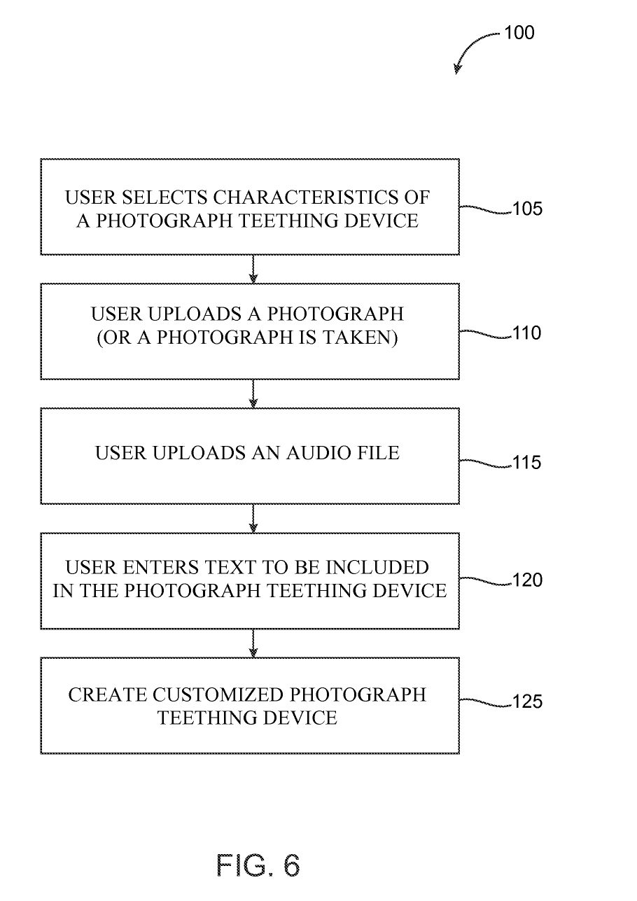

FIG. 6 is a flow chart of an exemplary method 100 of making the photograph teething device. It is to be appreciated that the method 100 of making is typically performed in the context of an on-line system or in-store kiosk. However, other modes of making the photograph teething device are contemplated.

In operation 105, a user selects various characteristics to the photograph teething device. These characteristics can include, but are not limited to, size, shape, color, patterns, surface type, etc. Next, a photographic image is uploaded to be inserted into or otherwise reproduced within the photograph teething device (operation 110). Additionally, the photographic image may actually be taken prior to it being uploaded. For example, when method 100 is performed in an in-store kiosk setting the photographic image of the user may be taken as a first step. Similarly, a version of the on-line system may be adapted to take a photographic image via a web camera. The photographic image is typically inserted into or otherwise reproduced within the interior portion of the photograph teething device.

In some embodiments of the photograph teething device (e.g., the fifth embodiment teething photograph device) the user can upload an audio file as described in operation 115. The audio file can contain any desired message, typically short in length, that the user wishes to be activated within the photograph teething device. For example, the audio file may include “Mommy loves you!”, “Daddy misses you!”, or “Peek-a-boo, Grandma sees you!” Moreover, a plurality of messages may be included that either can be rotated through or randomly shuffled upon activation. As described with respect to operation 110, the audio file can be first recorded at an in-store kiosk or a version of the on-line system prior to being uploaded. The audio file can then be embedded into an audio system. The audio system, along with a light system (if such an option is selected by the user), is typically contained within the interior portion of the photograph teething device.

Next, as described in operation 120, the user enters text to be included in the photograph teething device. The text entered to be included in the photograph teething device can be for various purposes such as, but not limited to, text identifying the photographic image and informational text regarding the photographic image. The informational text can include, for example, contact information such as email addresses and phone numbers. When the photograph teething device is used for authorized release of a child the informational text can include a full name, height and weight of the person in the photograph as well as an answer to a security question.

Next, the customized photograph teething device is constructed and created according to the selected characteristics and items/information uploaded and entered (operation 125). The photograph teething device can be constructed by any number of methods, but importantly, the photographic image, text, and any implements related to the audio and/or light system should be substantially airtight and watertight within the photograph teething device. Hence, these items are typically contained with the interior portion of the photograph teething device and encapsulated by an exterior portion.

It is to be appreciated that the method of making photograph teething devices is merely exemplary. Variations of this method can be used to make different embodiments of the photograph teething device as would be apparent to one of ordinary skill given the benefit of this disclosure.

### An Exemplary Method for Authorizing Persons to Pick-Up a Child at a Facility Using Photograph Teething Devices

In addition to typical uses of the photograph teething device to provide comfort for a young child and to aid in developing the young child's cognitive recognition of a family members and/or friends, an exemplary method of authorizing persons to pick-up a child in a facility is disclosed herein. It is to be understood that the first, second, third, fourth, and fifth embodiment photograph teething devices 10, 20, 30, 40, and 50, as well as other embodiments and variations can be used with this exemplary method of authorizing persons to pick up a child at a facility.

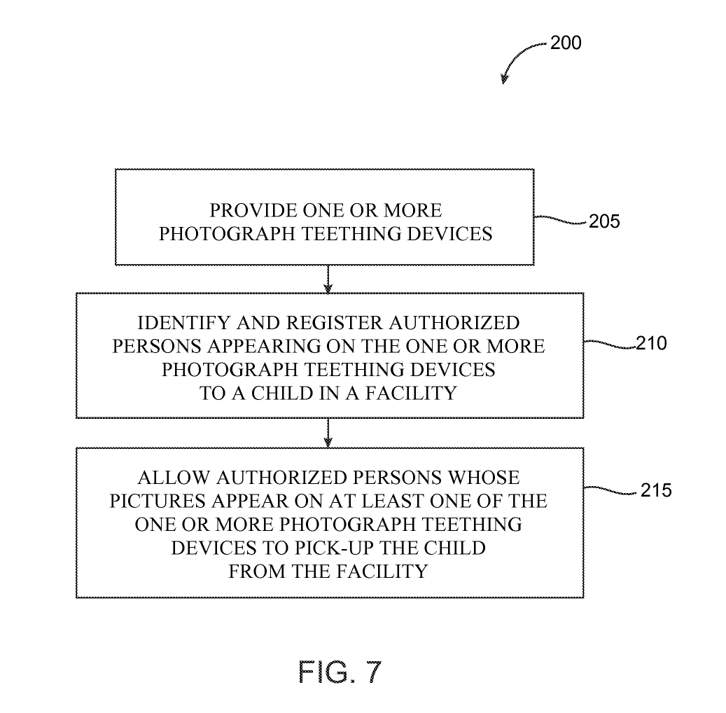

FIG. 7 is a flow chart of an exemplary method 200 of using a photograph teething device as a method of authorizing persons to pick up a child at a facility. It is pertinent to note that when embodiments of the photograph teething device are used in conjunction with method 200, they typically include text identifying the photographic image and informational text regarding person in the photographic image. Thus, the informational text can include, for example, contact information such as email addresses and phone numbers. Additionally, the informational text can include a full name, height and weight of the person in the photographic image as well as an answer to a security question or other ways to identify the person attempting to remove the child from the facility. Moreover, the photograph teething device can include a RFID tag or chip or the like such that the facility can easily detect when the child arrives at or leaves the facility.

As described in operation 205, one or more photograph teething devices are provided either to or by the facility. It is to be appreciated that while the facility used in conjunction with method 200 is typically a day-care facility or a preschool, other facilities and settings are contemplated such as, but not limited to, a library, community center, zoo, amusement park or similar attraction. It may be the responsibility of the parents to obtain the photograph teething devices for persons authorized to pick up the child. Alternatively, the facility may be responsible for obtaining the photograph teething devices and requiring the authorized persons to come to the facility to have the photograph teething devices made, for instance, with an in-store kiosk located on the premise.

Next, each of the one or more photograph teething devices representing a person authorized to pick up the child is registered by the facility. The identification and registration process can be any suitable process such as, but not limited to, a general or specific purpose computer adapted to track and log facility personnel, parent, and child entrance/exit activity. For example, the informational text in the photograph teething device can include an ID number that can cross-referenced to a database in the computer containing information regarding the child and the authorized person depicted in the photographic image of the photograph teething device. Additionally, the identification and registration process can include the use of a RFID tag or chip in the photograph teething device operatively coupled to associated security hardware and computer systems. It is to be appreciated that other identification and registration processes are contemplated as would be apparent to a skilled artesian given the benefit of this disclosure.

Still referring to FIG. 7, the facility allows authorized persons whose photographic image appear on at least one of the one or more photograph teething devices to pick-up the child from the facility (operation 215). By using method 200, the facility can more expediently and securely provide child release procedures thereby reassuring the parents of the child and potentially reducing liability of the facility. These benefits, of course, are in addition to the benefit of the child using the one or more photograph teething devices to receive cognitive recognition of and comfort from the chewable renditions of his or her loved ones.

Again, it is to be appreciated that the method of using the photograph teething devices described above is merely exemplary. Variations of this method can be used to track, monitor, and identify either the child or persons associated with the child as would be apparent to one of ordinary skill given the benefit of this disclosure.

### Alternative Embodiments and Variations

The various embodiments and variations thereof, illustrated in the accompanying figures and/or described above, are merely exemplary and are not meant to limit the scope of the invention. It is to be appreciated that numerous other variations of the invention have been contemplated, as would be obvious to one of ordinary skill in the art, given the benefit of this disclosure.

For example, in some embodiments the photographic image can be that of the family pet instead of a person and in other embodiments the photographic image can be that of the child's entire family. Moreover, a plurality of individual photographic images and accompanying text can be incorporated into a single photograph teething device. For instance, a family photograph teething device portrait may comprise a body section having a ring-like structure (similar to a large teething ring) with a plurality of circular portions whereby each circular portion has a photographic image and accompanying text of each person in the family.

Other variations can have a mild flavoring imparted in the external portion of the body section to entice the child to use the photograph teething device. All variations disclosed in this application are intended and contemplated to be within the spirit and scope of the invention.

I claim:

1. A photograph teething device comprising:
a body section, the body section comprising,
a first side surface,
a second side surface,
an interior portion comprising a photographic image, and a substantially transparent external portion, the substantially transparent external portion being comprised of a babyproof material and encapsulating the interior portion; and
an attachment section.

2. The photograph teething device of claim 1, wherein the interior portion further comprises at least one of (i) text identifying the photographic image and (ii) informational text regarding the photographic image.

3. The photograph teething device of claim 2, wherein the photographic image faces the first side surface and the at least one of (i) text identifying the photographic image and (ii) informational text regarding the photographic image faces the second side surface.

4. The photograph teething device of claim 1, wherein the body section is substantially rectangular.

5. The photograph teething device of claim 1, wherein the substantially transparent external portion has a Durometer or Shore A hardness value between approximately 30 and 60.

6. The photograph teething device of claim 1, wherein least one of the first side surface and the second side surface is substantially planar.

7. The photograph teething device of claim 1, wherein at least one of the first side surface and the second side surface is substantially convex.

8. The photograph teething device of claim 1, wherein at least one of the first side surface and the second side surface is substantially textured.

9. The photograph teething device of claim 1, wherein:
(i) at least one of the interior portion and the exterior portion includes a color dye infused therein; and
(ii) the body section further includes one or more fluid cavities disposed within the substantially transparent external portion.

10. The photograph teething device of claim 1, wherein the attachment section comprises an aperture extending through the first side surface and the second side surface.

11. The photograph teething device of claim 10, further comprising a strap operatively coupled to the aperture.

12. The photograph teething device of claim 1, wherein the attachment section comprises an elongated segment of the substantially transparent external portion.

13. The photograph teething device of claim 1, further comprising one or more attraction implements.

14. The photograph teething device of claim 13, wherein at least one of the one or more attraction implements includes an audio system adapted to store an audio file and emit sound.

15. The photograph teething device of claim 13, wherein at least one of the one or more attraction implements includes a light system adapted to emit light.

16. A method of making the photograph teething device of claim 1, the method comprising:
selecting characteristics of the photograph teething device, the characteristics of the photograph teething device including size, shape, and surface type; and
uploading a photograph to be used as the photographic image within the interior portion;

17. A method of making the photograph teething device of claim 2, the method comprising:
selecting characteristics of the photograph teething device, the characteristics of the photograph teething device including size, shape, and surface type;
uploading a photograph to be used as the photographic image within the interior portion; and
entering text to be used (i) text identifying the photographic image and (ii) informational text regarding the photographic image.

18. A method of making the photograph teething device of claim 14, the method comprising:
selecting characteristics of the photograph teething device, the characteristics of the photograph teething device including size, shape, and surface type;
uploading a photograph to be used as the photographic image within the interior portion; and
uploading the audio file to be used in the audio system.

19. A method for authorizing persons to pick up a child from a facility, the method comprising:
providing one or more photograph teething devices, each of the one or more photograph teething devices comprising a body section and an attachment section, the body section comprising,
a first side surface, a second side surface, an interior portion comprising a photographic image of an authorized person to pick up the child and at least one of (i) text identifying the photographic image and (ii) informational text regarding the photographic image, and a substantially transparent external portion, the substantially transparent external portion being comprised of a babyproof material and encapsulating the interior portion;
registering each of the one or more photograph teething devices to the child in the facility; and
allowing the authorized person to pick up the child from the facility.

20. The method recited in claim 19, wherein the facility is one of a day-care facility and a preschool.
